(19) United States
(12) Patent Application Publication
(10) Pub. No.: US 2007/0149222 A1
(43) Pub. Date: Jun. 28, 2007

(54) Methods, application server, and terminal for directive person identification and communication

(76) Inventors: Berislav Hodko, Kirkland (CA); Ulf Olsson, Sollentuna (SE)

Correspondence Address: Alex Nicolaescu;Ericsson Canada Inc., Patent Department, 8400 Decaric Blvd., Town Mount Royal, QC, H4P 2N2, CA

(21) Appl. No.: 11/317,172

(22) Filed: Dec. 27, 2005

(51) Int. Cl. H04M 3/42; H04M 3/00; H04Q 7/20; H04M 5/00

(52) U.S. Cl. 455/461; 379/265.05; 379/207.02

(57) ABSTRACT

Methods, server, and terminal are provided for allowing an initiating party to “finger-point” another party targeted for communication using an electronic terminal and as a consequence of such “finger-pointing”, to retrieve at least an indication of the identity of a mobile terminal of the targeted party to establish a communication therewith. In a first embodiment, the “finger-pointing” comprises pointing a camera-enabled terminal and acquiring a picture of the targeted party, which is translated by the server using picture analysis techniques into a terminal address. In another embodiment, the “finger-pointing” comprises targeting the party with a directive antenna emission to obtain a radio identifier of the targeted party, which is translated by the server into an identity of the targeted party to establish a communication therewith. In yet another embodiment, the initiating party also provides location information to the server, so that the server parses only records that match the location information thus reducing identification time.

### BACKGROUND OF THE INVENTION

1. Field of the Invention

The present invention relates to a method, system, and node for communicating with a targeted party intended for communication.

2. Description of the Related Art

With the improvement of communication means in the last few decades, people-matching techniques have followed and have been enhanced with the help of technology. One such technique involves the use of a telephone for accessing a voice based people-matching system where men and women can enter their own profile as a spoken description, can lease into somebody else's profile description in order to select a matching person. Such systems typically use DTMF tones as an input and selection means users can employ in order to browse the system's menu.

An improvement over such a system is described in the PCT patent application publication WO 2004/003705 A2 in the name of Brady James V. (hereinafter called Brady). Brady teaches a location-based and preferences-based system and method for matching profiles and characteristics of persons, places, and things with the express preferences of mobile users, and to alert and direct such users to any places having attributes matching the users express preferences. The user has a Global Positioning System (GPS)—capable PDA that stores preferences of the user and which communicates with a server containing profiles of persons, places, or things. The comparison of the user's preferences with the various profiles allows a user only to be informed of those persons, places and or things that he is likely to be interested in. The teaching of Brady is thus limited to the selection of persons or places solely based on an electronic profile stored in an electronic device.

The PCT patent application publication WO 2002/01405 A1 in the name of Hancock John (hereinafter called Hancock) also bears a relation with the field of the present invention. Hancock teaches a people networking system that allows users to locate people with the same interests or to find people who would satisfy a current need (e.g. a Job vacancy). Such a system may make use of existing telecommunications networks such as the Internet, WAP, GPS, and other protocols to provide users' location information. Each user of the system provides a personal profile of their business, social, or private interests and the system users may log in to the system via an Internet access device or a mobile phone to search the system database for compatible matches. Any confirmed match may be sent a text message in which the sender's anonymity is preserved. Hancock's system also performs people-matching solely on the base of an electronic profile.

Many systems make use of a critical information associated with persons interested in people-matching services, i.e. of the proximity or location information associated with each user. Location information provides the advantages that people are only proposed matches which are in their proximity, thus giving the system more appeal for users and clients. Such a system is described in the US patent application publication US 2004/0006548 A1 in the name of Valadi Mahmood (hereinafter called Mahmood). Mahmood teaches a subscriber profile matching and positioning system for mobile units, wherein mobile telephones are connected to a server that contains a database having information on persons looking to meet other persons. Using the telephones, information can be input to the server regard of a person looking to meet another person. The server receives personal information, stores it in the database and compares the personal information to find other persons, the information of whom matches the received information on the first person. In the case where the telephones are mobile phones, the server can have the feature of determining the geographical locations thereof, and when the geographical distance between the two mobile telephones is small, to give a signal thereof to the mobile telephones such as activating a ring signal and establishing a telephone connection between them.

Another location-based people-matching system is disclosed in the French patent application number 0011839 which publication number is 2,814,313. This French patent application discloses a people-matching system wherein a personal profile of a user is rather stored in his own mobile device, which comprises an emitter and a receiver. When two mobile devices are in close proximity, they detect each other via short-range radio means, the two users' profiles are compared with each other, and when a match is found personal data is exchanged between the two devices so that the users of the devices can meet. However, this patent application also allows people-matching to be performed based on a personal profile stored within the mobile device.

Conclusively, although various people-matching techniques are known in the art including location-based people-matching systems, they all allow for people-matching to be performed using electronic personal profiles containing personal preferences and information related to each user, which are compared with another user's preferences and/or information for a match to be established. However, people-matching techniques exclusively based on the proximity of one user with respect to another user are impracticable with cellular systems because in the absence of personal profile comparison and matching, the number of returned matches found within a certain graphical area is simply too large, and thus unmanageable. This is why, even the above described French patent application only mentions a technique of people-matching using a combination of short-range radio and profile matching.

To date, there exist no people-matching or communications systems allowing for a communication to be established simply by “finger-pointing” a targeted person intended for communications using, for example, an electronic device.

### SUMMARY OF THE INVENTION

It should be readily appreciated that in order to overcome the deficiencies and shortcomings of the existing prior art solutions, it would be advantageous to have a method and system for effective people-matching or simply for communications allowing for a communication to be established simply by “finger-pointing” a (visible or not visible) targeted person intended for communications using, for example, an electronic device or terminal having a pointing module. The present invention provides such a method, system, and user terminal.

The present invention provides for methods, a mobile terminal (or device) and application server that allow an initiating mobile terminal user to “finger-point” an intended target for communication, such as for example another mobile user, using a pointing module of his mobile terminal, and as a consequence of such “finger-pointing”, to retrieve sufficient information (e.g. an indication of the identity) related to the targeted user to be able to communicate with him or her.

In one aspect, the present invention is a method for communication between a terminal and a party targeted for communication, the method comprising the steps of:

a. receiving information about a party targeted for communication from a terminal that physically points towards the party targeted for communication for acquiring the information; and

b. translating the information about the party targeted for communication into an indication of an identity of the party targeted for communication for establishing a communication between the terminal and the party targeted for communication.

In another aspect, the present invention is an application server, comprising:

a communication module receiving information about a party targeted for communication from a terminal that physically points towards the party targeted for communication for acquiring the information;

a database storing a plurality of associations between information of mobile terminals and indications of identities the mobile terminals; and

a processing module that receives from the communication module the information about the party targeted for communication and retrieves from the database an indication of an identity of the party targeted for communication for establishing a communication between the terminal and the party targeted for communication.

In yet another aspect, the present invention is a terminal comprising:

a pointing module arranged to physically point towards a party targeted for communication when the terminal is placed in a certain position, the pointing module acquiring information about the party targeted for communication; and

a communication module communicating with the party targeted for communication based on the information about the party intended for communication.

In yet another aspect, the present invention is a method for communication using a terminal, the method comprising the steps of:

a. acquiring information about a party targeted for communication using the terminal, the terminal being arranged to physically point towards the party targeted for communication to acquire the information; and

b. communicating with the party targeted for communication based on the information about the party intended for communication.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary high-level nodal operation and signal flow diagram illustrative of the preferred embodiment of the present invention;

FIG. 2 is an exemplary high-level representation of an aspect of the preferred embodiment of the present invention;

FIG. 3 is an exemplary high-level representation of another aspect of the preferred embodiment of the present invention;

FIG. 4 is another exemplary nodal operation and signal flow diagram illustrative of variants of the preferred embodiment of the present invention;

FIG. 5 is yet another exemplary nodal operation and signal flow diagram illustrative of another variant of the preferred embodiment of the present invention;

FIG. 6 is an exemplary high-level block diagram illustrative of a mobile device that can be used for performing the preferred embodiment of the present invention; and

FIG. 7 is an exemplary high-level block diagram illustrative of a server that can be used for performing the preferred embodiment of the present invention.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

It should be readily appreciated that in order to overcome the deficiencies and shortcomings of the existing prior art solutions, it would be advantageous to have a method and system for effective people-matching or communications allowing for a communication to be established simply by “finger-pointing” a (visible or not visible) targeted person intended for communications using, for example, an electronic device or terminal having a pointing module. The present invention provides such a method, system, and user terminal.

The present invention provides for methods, mobile device and application server that allow an initiating mobile terminal user to “finger-point” an intended target for communication, such as for example another mobile user, who may be visible to the initiating user or alternatively, who may be part of a object such as a car or a building, using a pointing module of his mobile terminal, and as a consequence of such “finger-pointing”, to retrieve sufficient information (e.g. an indication of the identity) related to the targeted user to be able to communicate with him or her. The present invention proposes various exemplary means for achieving the “finger-pointing” of the intended target for communication.

In a first variant of the preferred embodiment of the invention, the “finger-pointing” of the party targeted for communication is achieved by obtaining the indication of the identity of the user targeted for communication in the form of a picture of the party intended for communication. For example, a first user uses a mobile terminal pointing module including a digital camera for taking a picture of another user who is in sight. Once the picture is taken, the first user may perform picture adjustment, such as for example by cropping the portrait of the other user from the original picture using a graphical application on his mobile device, and to further send the adjusted picture to an application server. The later uses the picture representing the person targeted for communication to match a mobile terminal address of the person intended for communication. When such match is found, the server either returns the address of the party intended for communication to the first user so that the first user can communicate with the intended party for communication, or alternatively directly establishes a communication between the users without sending the address of the targeted terminal to the first user, thus preserving the privacy of the party targeted for communication.

In a second variant of the preferred embodiment of the invention, the “finger-pointing” of the party targeted for communication is achieved by obtaining the indication of the identity of the user targeted for communication in the form of a radio identifier of the targeted mobile terminal by radio contacting that mobile terminal using a pointing module that includes a directive antenna of the first user's mobile device. A directive antenna is defined as a radio antenna that emits radio signals only in a given direction (optionally, the directive antenna may also only receive radio signals only from that direction). For example, the first user may physically point his directive antenna-enabled mobile terminal towards the party intended for communication, and may ping that party with a radio message requesting the establishment of a communication therebetween. In such circumstances it may not be necessary that the targeted user is visible to the initiating party. The mobile terminal of the targeted mobile user may answer back either with his/her full mobile terminal address or phone number, or with an anonymous radio identifier which is only known to an application server, in which case the application server may perform a translation between the anonymous radio identifier and the mobile terminal address or phone number. In both cases, the communication can be established between the first user and the user targeted for communication, either directly between the mobile devices, or using the application server, as a result of the radio-based “finger-pointing” of the targeted person for communication. It is to be noted that the term radio identifier as used herein designates any type of identifier of the targeted mobile terminal, including for example its full terminal address (to be used for example when no privacy concerns are taken into account in a given implementation when the targeted terminal returns its full address to the initiating party) or just an indication of the terminal address only known to a server.

As it can be observed, the present invention thus provides an easy and effective manner for contacting a party intended for communication who is in sight of a first user, by allowing the first user to physically point a pointing module of an electronic device, such as for example of a mobile terminal, towards the party targeted for communication, and as a result, to retrieve sufficient information about the party targeted for communication (e.g. an indication of the identity of that party), to be able to establish a communication with that party. Such a communication may be established, for example, using traditional voice communication (e.g. circuit-switched voice, Voice over IP (VoIP), via text messaging (e.g. SMS (Short Messaging Service), MMS (Multimedia Messaging Service), chat, etc), or via videoconferencing. By allowing communications and people-matching to be performed by a physical “finger-pointing” of the party intended and targeted for communication, e.g. by radio or optical means as described herein, the present invention goes further and beyond the prior art techniques for people-matching, where communications were possible only based on an electronic match of two personal profiles electronically stored in a server, and where the persons were not in sight of each other.

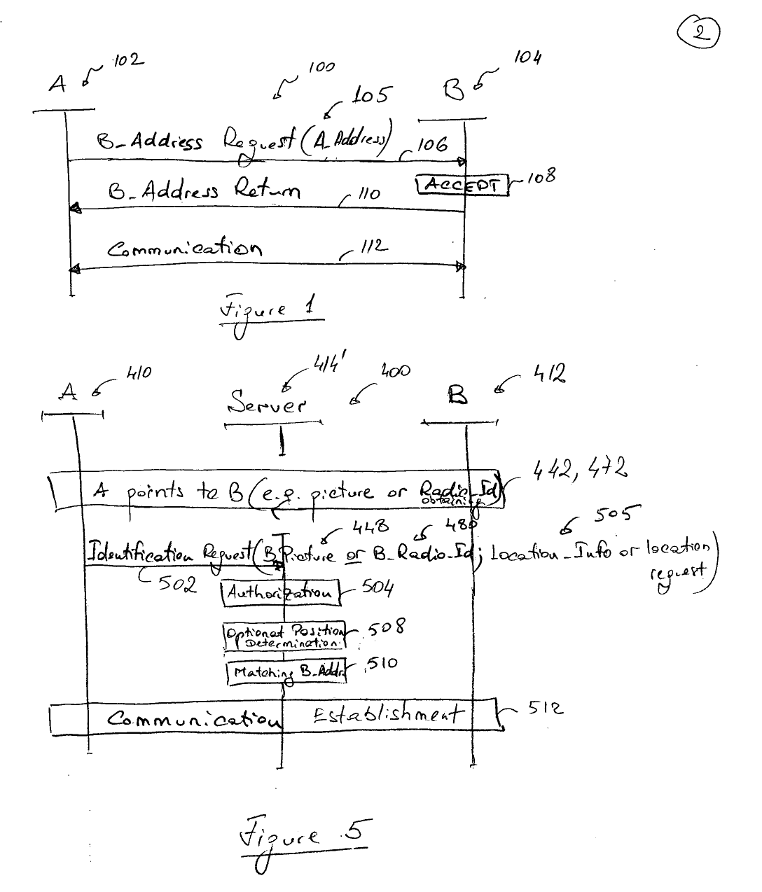

FIG. 1 is an exemplary high-level nodal operation and signal flow diagram illustrative of the preferred embodiment of the present invention. Shown in FIG. 1 is a telecommunications network 100 that may comprise a cellular telecommunications network, and mobile user terminals A 102 and B 104. In action 106, the user of terminal A 102, who is for example in sight of the user of terminal B 104, physically points the mobile terminal A 102 towards user terminal B 104, which belongs to the user intended for communication, and requests at least an indication of the identity or address of the mobile user terminal B 104. Such action may comprise, for example, taking a picture of the user of terminal B 104, or sending a directive radio message to the terminal B 104 which optionally comprises the address or identity 105 of terminal A 102, using for example a directive antenna of the terminal A 102. In the later case where a radio message is sent to terminal B 104, the method may comprise the step of having the user of that terminal accepting to return the indication of his address to terminal A 102, action 108. Then, the indication of the identity of the terminal B 104 is returned in action 110 using for example a short-range radio interface, such as for example Bluetooth, or any other communication means such as SMS, MMS, or the like. Such action is possible because terminal B 104 received the address 105 of terminal A 102 in action 106. In both cases, in action 112, a communication is established between the user of terminal A 102 and the user of terminal B 104 using the indication of the address of terminal B 104.

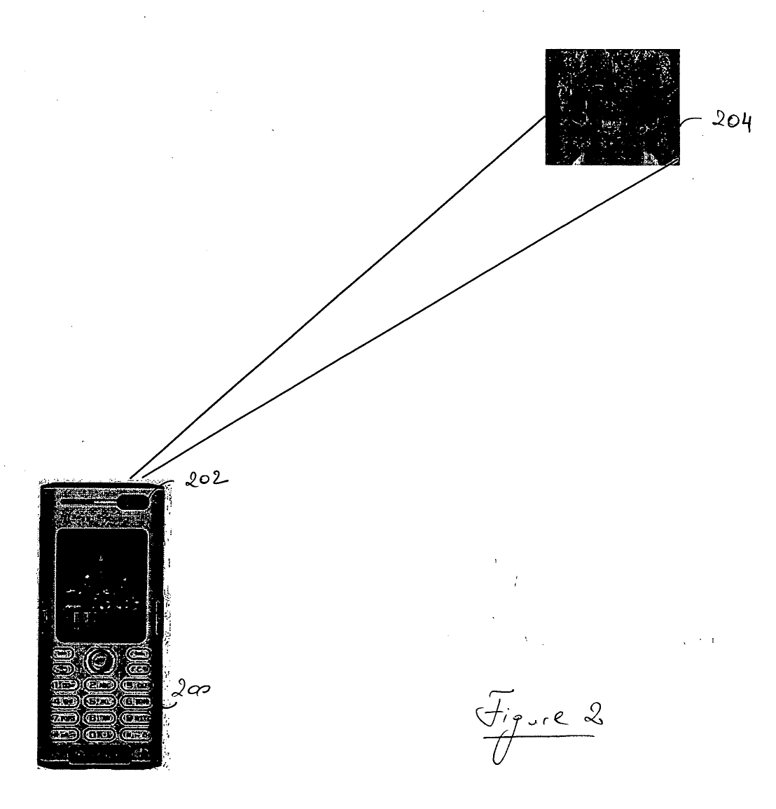

FIG. 2 is an exemplary high-level representation of an aspect of the preferred embodiment of the present invention related to use of a camera-enabled mobile device (also called herein mobile terminal) 200, which is alike the terminal A 102, previously described, for taking a picture of a targeted party intended for communication. According to the present aspect of the preferred embodiment of the invention, a first user (also called herein a party) who desires to initiate a communication with a second user targeted for communication by the first user and who is visible to the first user, may use his mobile device 200 that has an embedded digital camera 202 in order to take a picture of the second user 204 targeted for communication. Once the picture is taken by the first user's camera, it can be optionally adjusted so that the portrait or face of the targeted party is cropped of other nonessential portions of the graphical picture in order to facilitate face recognition, and then sent to an application server capable of associating the adjusted picture with a terminal address of a the second user, which is to be used for establishing a communication between the first user in the second user. Thus, the present aspect of the preferred embodiment of the invention allows a person that spots another person who he or she desires to contact, to take a picture, even from a certain distance, adjust the picture to facilitate face recognition, send that picture to an application server for picture-to-address conversion, so that a communication can be established between a terminal of the first person and a terminal of the second person.

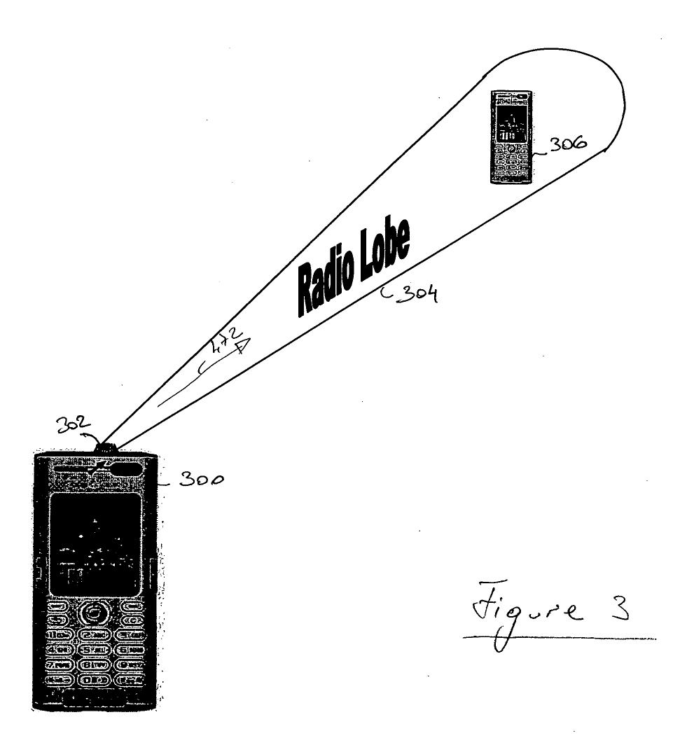

FIG. 3 is an exemplary high-level representation of another aspect of the preferred embodiment of the present invention related to use of a directive antenna-enabled mobile device 300 for radio contacting a targeted party intended for communication. According to the present aspect of the preferred embodiment of the invention, a first user who desires to initiate a communication with a second user targeted for communication and who may be visible to the first user, uses his mobile device 300 that has a directive antenna 302 in order to send a radio message to the second user targeted for communication. The terminal 300 is so pointed by his user so that the radio lobe formed by the radio coverage of the directive antenna 302 covers the mobile terminal 306 of the party intended for communication. That party thus receives the communication request message sent from the terminal 300, accepts the communication request, and replies back with an indication of the identity of the terminal 306, so that communication can be established between terminals 300 and 306. The reply of the terminal 306 towards the terminal 300 can be made in various manners, such as for example using short-range radio technologies such as Bluetooth or any other kind of messaging interface, such as for example SMS, MMS, voice, or chat. The antenna 302 may be directive not only in emission, but also in reception, so that only replies from the given direction are received by the antenna, thus facilitating communication solely with the targeted user.

Reference is now made to FIG. 4, which is an exemplary nodal operation and signal flow diagram illustrative of a possible implementation variant of the preferred embodiment of the present invention. Shown in FIG. 4 are user terminals A 410 and B 412 located in proximity with each other, such as for example by being visible to each other. Such user terminals may be mobile user terminals, although other kinds of terminals could be contemplated as well. Further shown in FIG. 4 is an application server 414 which may implement, for example, a people-matching application (also called service) or a communications application responsible for enabling person identification and person-to-person communication in a manner that is yet to be described. In the exemplary scenario described in relation to FIG. 4, it is assumed that the user of terminal A 410 sees the user of terminal B 412 in close proximity, such as for example at a close table in a bar or discotheque, and desires to contact that user via his/her mobile terminal A 410. To be able to do so, the user of terminal A 410 may first need to register with the people-matching application server 414 in order to be able to be provided people-matching service by the server 414. Such action may take place with a registration message 416 being sent from the mobile terminal 410 to the server 414, the message 416 including user authentication data 418, such as user identity, security and/or accounting credentials and the like, that are to be used by the server 414 in order to authenticate and authorize the user of mobile terminal A 410 to receive people-matching service. Optionally, the message 416 may further comprise a digital picture 420 of the user of the mobile terminal A 410, and a radio identifier 422 that may have the form of a radio signature or of a numeric identifier of the mobile terminal A 410. In action 424, the server 414 authenticates and authorizes the user of the mobile terminal A 410 for being provided people-matching service, and optionally stores the picture 420 and the radio identifier 422. The user of the mobile terminal B 412 may also need to register with the server 414 in order to be provided appropriate people-matching service by that server. Such action may take place with an analogous registration message 426 being sent to the server 414, the message including authentication data 428, a digital picture 430 of the user of the mobile terminal B 412, and a radio identifier 432, which may be in a form of a radio signature or of a numeric identifier of the mobile terminal B 412. Upon receipt of message 426, the server 414 also stores the digital picture 430 and the radio identifier 432 for the terminal B 412.

Reference is now additionally made to FIG. 7, which is an exemplary high-level block diagram illustrative of the server 414 that can be used for performing the preferred embodiment of the present invention. The server 414 may comprise an authorization and authentication module 702 responsible for authorizing and authenticating mobile terminals such as the mobile terminals A 410 and B 412 based on their respective authentication data in order to authorize or deny service. In some implementations, the authorization module 702 may be implemented in a module which is external to the server 414, and therefore at least part of actions 424 and 434 may be performed externally to the server 414 (scenario not shown in FIGS. 4 and 7). The server 414 further comprises a picture database 708 that stores associations 709 between digital pictures of users on one side and terminal addresses, terminal numbers, terminal identities or identifiers of such users on the other side, all of which are herein designated as terminals addresses. Therefore, the data contained in the picture database 708 allows the server 414 to translate between a given digital picture of a user and a terminal address. It is upon receipt of registration messages as described herein before, that the server 414 may populate its picture database 708 with associations 709 between the received picture of a given user and terminal addresses, which may be extracted from the authentication and authorization data of that user. Optionally, the database 708 may further comprise, for each such association, location information indicative of a last location registered for each terminal address. The location information may be obtained by the server 414, for example, from a location server (not shown) or via other suitable means depending upon the implementation.

The server 414 further comprises a radio identifier database 706 that stores associations 707 between radio identifiers of users on one side, and terminal addresses of such users on the other side. Therefore, the data contained in the radio identifier database 708 allows the server 414 to be capable of also translating a given radio identifier of a user and his terminal address. It is upon receipt of registration messages as described herein before, that the server 414 may populate its radio identifier database 706 with associations 707 between the received radio identifier of a given user and his terminal address, which may be extracted from the authentication data of that user. Optionally, the database 708 may further comprise, for each such association, location information indicative of a last location registered for each terminal address. This location information may also be obtained by the server 414, for example, from a location server (not shown) or via other suitable means depending upon the implementation.

The server 414 further comprises a communication module 710, which receives and sends messages from and to user terminals, like from and to terminals 410 and 412, and a processing module 704, which based on the information contained in the database is 706 and 708 performs the processing, matching, and communication required to identify a terminal address.

Once the mobile terminals A 410 and B 412 are provided authorization for people-matching service supported by the server 414 in actions 424 and 434, at any moment they may request such a service, or alternatively, such a service may be requested without prior registration and authorization. This is may be performed in various ways.

In a first variant of the preferred embodiment of the invention described in action 440, the user of the mobile terminal A 410 may obtain the indication of the identity of the targeted party for communication in the form of a picture of that user. For this purpose, the initiating user may use a digital camera of the mobile terminal 410 for taking a picture of the user of the mobile terminal B 412, and to request the identification of the user targeted for communication based on the picture, and further the establishment of a communication therewith, in an action analogous to the one described in relation to FIG. 2. Part of action 440, the user of mobile terminal A 410 takes a picture of the user of the mobile terminal B 412, action 442, using a digital camera embedded in the mobile terminal A 410.

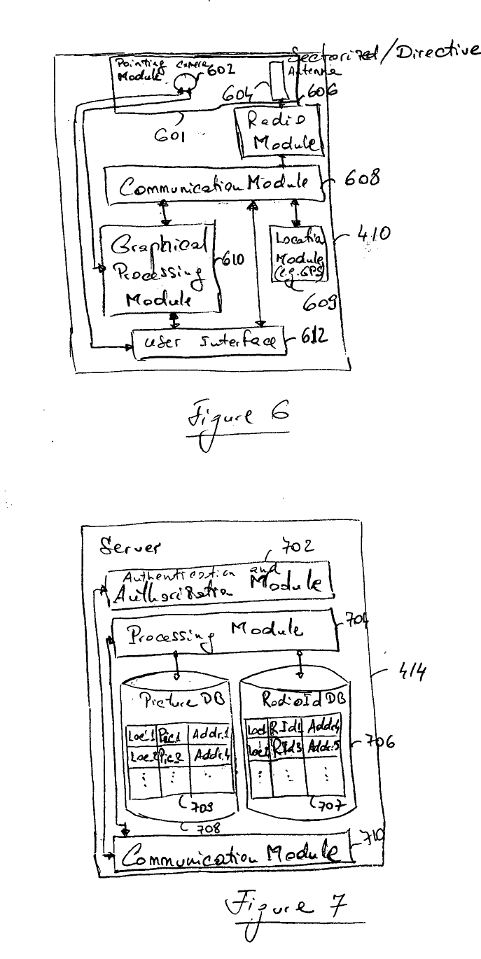

Reference is now additionally made to FIG. 6, which is an exemplary high-level block diagram illustrative of the mobile device A 410 that can be used for performing the preferred embodiment of the present invention. The mobile device A 410 comprises a pointing module 601 that may be oriented by the user towards the party targeted for communication in order to request and/or obtain the indication of the identity of the targeted party. For example, the pointing module 601 may comprise a digital camera 602 capable, when pointed towards a user of taking digital pictures with sufficient resolution and colors as to enable identity recognition of photographed persons based on graphical analysis. The mobile device A 410 further comprises a graphical processing module 610, that may be based for example on a graphical processing application installed in the mobile terminal 410 for allowing the user to graphically adjust the digital pictures taken by the digital camera 602. This is also enabled by, for example, a user interface module 612 that may comprise a keypad, keyboard, and/or pointing device in association with a color display. Finally, the terminal 410 may also comprise a location module 609, such as for example a GPS module or a network-based position determination module, capable of determining the position of the terminal 410.

After having taken the picture of the party intended for communication, which in the present case is the user of the mobile terminal B 412, the user of the mobile terminal A 410 may use the graphical processing module 610 to adjust and/or crop the picture taken of the other user, for example to better show the portrait and/or the face of that user, action 443. In action 444, the user of mobile terminal A 410 sends an identification request message to the server 414 that includes the address 446 of mobile terminal A 410, and the digital picture 448 of the user of mobile terminal B 412. Upon receipt of the message 444, the server 414 may optionally yet again perform authorization and/or authentication of mobile terminal A 410 using its authorization module 702, action 450, and in action 452 may use the processing module 704 to perform digital picture analysis of the received digital picture 448. As a result, the processing module 704 may identify which one of the pictures of the picture database 708 most closely corresponds to the received digital picture 448, and the may determine the terminal address or identity associated to the closest picture match. That terminal address or identity is assumed to be the one of the mobile terminal B 412.

Then, in action 454, the server 414 uses its communication module 710 to return the determined address of the mobile terminal B 412 to the terminal A 410, so that the later can contact the terminal B 412. The server 414 sends to the terminal A 410 an identification reply message 454 comprising the determined terminal address 456 of the terminal B 412. Then, terminal A 410 can initiate a communication with the mobile terminal B 412 using the received address of the mobile terminal B 412, wherein such communication may be established in various manners, such as for example using SMS chat, or MMS messaging, or a voice-based communication.

Action 454 is not the only manner in which a communication can be established between terminals A 410 and B 412 using the determined address of terminal B 413. Action 460 presents an alternate manner: once the terminal address 456 of the mobile terminal B 412 is determined by the server 414, the later does not return the determined terminal address to the terminal A 410 but rather itself initiates a communication between the terminals A 410 and B 412. This variant has the advantage of keeping the terminal address of the mobile terminal B 412 unknown to the terminal A 410. For this purpose, it is the server 414 that initiates the communication by using its communication module 710 to send communication requests 462 and 464 to the terminals 410 and 412, so that the communication between terminals A 410 and B 412 is established in action 466 (in the case of a voice or chat session). Again, such a communication can be established using various means such as for example via messaging such as SMS, MMS, or chat, or even using voice based communications. For example, Session Initiating Protocol (SIP) can be used for the signaling 462 and 464 in order to open a SIP-based session that supports communications between the involved parties.

With the first variant of the preferred embodiment of the invention, it thus becomes possible for a first party to take a picture of a second party targeted for communication and which is in close proximity to the first party, to further request the identification of the second party (that may be kept unknown to the first party) and to allow for a communication to be established between the first and the second party.

In a second variant of the preferred embodiment of the invention described in action 470, it is proposed yet another manner of identifying a party targeted for communication. According to this variant, in order to obtain the indication of the identity of the party targeted for communication, terminal A 410 sends a targeted radio request message 472 for a radio identifier of the mobile terminal B 412 of the user targeted for communication, wherein the message may also comprise an identifier 474 of the mobile terminal A 410, and a picture 475 of the user of the terminal A 410. Such an action is also shown in relation to FIG. 3, where the message 472 is sent using the directive antenna of the mobile terminal A 410 (300 in FIG. 3) that directs the radio message in the direction of the mobile terminal B 412. FIG. 6 also shows the pointing module 601 that comprises a directive antenna 604 connected to a radio module 606 of the mobile terminal 410.

As a result, the user of mobile terminal B 412 is displayed a contact request on his mobile terminal 412, and using, for example, a keypad of the terminal the user accepts the contact request, action 476, by seeing the picture 475 of the requestor user and considering whether or not a communication with that person should be accepted. Consequently, the mobile terminal B 412 returns to mobile terminal A 410 a request return message 478 comprising a radio identifier 480 of the mobile terminal B 412 that is an indication of the identity of terminal B 412 that may not reveal the terminal address of that terminal to terminal A 410. Furthermore, the message 472 may also comprise a picture 481 of the targeted party B. The transmission of the message 478 may be achieved using various transmissions, such as SMS, MMS, short range radio transmission means such as Bluetooth and the likes. In action 482, the mobile terminal A 410 may select to establish a communication with the mobile terminal B 412. Such an action may be especially useful in situations where when physically pointing the mobile terminal A 410 towards a party intended for communication, the radio lobe 304 generated by the directive antenna encompasses not only the intended target for communication, which in the present case is mobile terminal B 412, but also other mobile terminals which respond back to the terminal A 410. Therefore, a selection 482 may be performed by user A that allows the user to select the desired party intended for communication from multiple parties, using for example the picture 481.

In action 484, the user of mobile terminal A 410 sends an identification request message to the server 414 that may also include the address 446 of mobile terminal A 410, along with the radio identifier 480 of the mobile terminal B 412. Upon receipt of the message 484, the server 414 may optionally yet again perform authorization or authentication of mobile terminal A 410 using its authorization module 702, action 485, and in action 487 may use its processing module 704 to identify the terminal address of the mobile terminal B 412 based on the radio identifier 480. For this purpose, the processing module 704 of the server 414 identifies in its radio identifier database 706 the radio identifier that most closely corresponds or that matches the radio identifier 480, and then retrieves the terminal address associated to the determined closest match, which is assumed to be the terminal address of the mobile terminal B 412. Then, in action 486, the server 414 uses its communication module 710 to return the determined address of the mobile terminal B 412 to terminal A 410, so that the later can contact the terminal B 412. The server 414 sends to the terminal A 410 an identification reply message 488 comprising the determined terminal address 456 of the terminal B 412. Then, terminal A 410 can initiate a communication 490 with the mobile terminal B 412 using the received address of the mobile terminal B 412, wherein such communication can be established in various manners, such as for example using SMS, chat, or MMS messaging, or voice-based communications, in a manner that is known in the art. Alternatively, in action 492, once the terminal address 456 of the mobile terminal B 412 is determined by the server 414, the later refrains from returning the determined terminal address to the terminal A 410 but rather itself initiates a communication between the terminals A 410 and B 412. This variant has the advantage that it keeps the terminal address of the mobile terminal B 412 unknown to the terminal A 410. For this purpose, it is the server 414 that uses its communication module 710 to initiates the communication by sending communication requests 494 and 496 to terminals A 410 and B 412, so that a communication therebetween is established in action 498. For example, the server 414 may send SIP Invite messages to both parties for inviting them to join a communication session. Again, such a communication may be established in various ways such as for example via messaging such as SMS, MMS, or chat, or even using voice-based communications. As mentioned, for example, SIP signaling can be used for the signaling 494 and 496 in order to open a SIP-based session that supports communications between the involved parties.

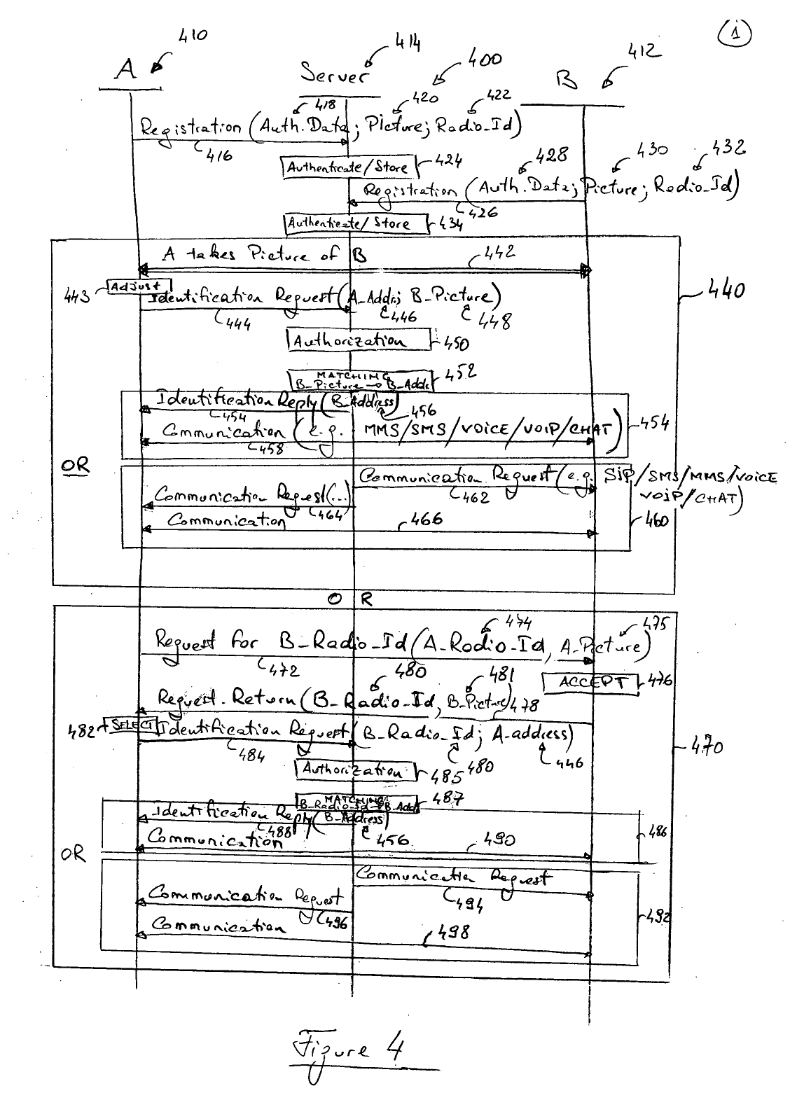

Reference is now made jointly to FIGS. 2, 3, 4, 6 and 7, previously described, and additionally to FIG. 5, which is yet another exemplary nodal operation and signal flow diagram illustrative of yet another variant of the preferred embodiment of the present invention that may be used along the ones described in relation to FIG. 4. Shown in FIG. 5 are the same terminals A 410 and B 412, and a server 414′ which may be alike the already described server 414, except for the fact it implement an additional feature related to the location of the party targeted for communication. In the exemplary scenario described in FIG. 5, the initiating terminal A 410 also is pointed towards the party targeted for communication, i.e. towards terminal B 412, but when the identification request is sent to the application server 414′, that request also comprises location information, such as a location indication of the terminal A 410, or of the terminal B 412 (since the two terminals are in close vicinity of each other, and given the granularity of the location information in a given network, the two location indications may coincide). Upon receipt of the identification request with the location information, the server 414′ knows the position of the party targeted for communication and thus scans or parses the picture database 708 or the radio identifier database 706 (depending upon whether a picture or a radio identifier is used for identifying the targeted terminal) only for those records storing pictures or radio identifiers that match the received location indication, thus significantly reducing the number of records being parsed and, as a consequence, reducing the time needed for matching the proper terminal address.

In actions 442 or 472 the initiating terminal A 410 is physically pointed towards the party targeted for communication and, if the radio contacting is used, the radio identifier 480, previously described, is returned to the terminal A 410. Optionally, the targeted terminal B 412 may also be configured to return its own location information 479 to terminal A 410 using the message 478 shown in FIG. 4. In action 502, an identification request is sent from the terminal A 410 to the application server 414′ in order to identify the terminal B 412 of the party targeted for communication. The message 502 includes, besides the picture 448 of the user of terminal B 412 or the radio identifier 480 and optionally the address of terminal A 410, also location information 505 relative to terminal A 410 or B 412, or a request to obtain location information about terminals A 410 or B 412 from a location server (not shown). Such location information may be provided directly from one of the terminals when terminals A 410 or B 412 are GPS-enabled or when the terminal is otherwise capable of calculating its own position, suing for example the location module 609 of terminal A 410. Alternatively, when a location request is included in message 504, location information relative to the specified terminal may be obtained from a location server in manners which are known in the art. It is assumed that because of the close vicinity of terminals A 410 and terminal B, either one of their respective locations can be used with this variant of the invention as an indication of the actual position of terminal B 412.

In action 504, the authentication and authorization module 702 of the server 414′ may yet again authorize and/or authenticate the terminal A 410. Upon positive result, further in action 508 the server 414′ may determine the position of terminal A 410 or B 412, in case the location information of the request 502 contained merely a location request and no actual location indication. Such action may also comprise contacting another location server (not shown) using for example the communications module 710. Then, the processing module 704 of the server 414′ determines the address of terminal B 412 based on the picture 448 or the radio identifier 480, by parsing only those records of the appropriate database (i.e. of the picture database 709 i the request 502 contained the picture 448 of the user of terminal B 412, or the radio identifier database 707 if the request 502 contained the radio identifier 480 of terminal B 412) that match the location information. As a result of action 510, the address of terminal B 412 is obtained, and in action 512 a communication can be established between terminal A 410 and terminal B 412, for example as described hereinbefore in relation to FIG. 4 in actions 454, 460, 486, or 492.

Therefore, with the present invention it becomes possible to establish contact and communicate with a targeted person in sight of another person, by physically pointing a device towards the targeted person, and as a result, obtain sufficient information about a terminal of the targeted person to be able to establish a communication therewith. Such information may include, for example, a digital picture taken by pointing a camera-enabled mobile terminal towards the targeted person, or a radio identifier of the mobile terminal of the targeted person obtained with the use of a directive antenna of a mobile terminal pointed towards the targeted person.

Based upon the foregoing, it should now be apparent to those of ordinary skills in the art that the present invention provides an advantageous solution, which goes further and beyond the existing prior art solutions, and thus offers simple yet effective people-matching and automatic communication establishment techniques. Although the system and method of the present invention have been described in particular reference to certain exemplary means for pointing towards a party targeted for communications (e.g. the pointing using a camera-enabled device and the directive antenna-enabled device), it should be realized upon reference hereto that the innovative teachings contained herein are not necessarily limited thereto and may be also implemented advantageously using other types of pointing and communication means. Furthermore, the invention may also be further used with any type of information obtained from the targeted party in order to decide to establish a communication with that party, such as for example the party's age, sex, membership to certain interest and/or focus groups, personal preferences such as movies, sports, activities, theater, charity and the like. Such information may be exchanged during the initial contact between the initiating party and the targeted party, and may serve in the selection and decision (e.g. call accept) for a communication to be established between the parties. Finally, although the exemplary preferred embodiment of the invention described hereinabove was portrayed with reference to a people-matching service, it is to be understood that the invention can also be used for other purposes, such as for example for establishing communications with targeted parties in emergency situations, for establishing communications with targeted audiences for commercial advertisement purposes, or for sending news to such a targeted audience. In such embodiments, the targeting can be advantageously made using the radio contacting of the targeted group. It is believed that the operation and construction of the present invention will be apparent from the foregoing description. While the method, system, and user terminal shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for communication between a terminal and a party targeted for communication, the method comprising the steps of:
a. receiving information about a party targeted for communication from a terminal that physically points towards the party targeted for communication for acquiring the information; and
b. translating the information about the party targeted for communication into an indication of an identity of the party targeted for communication for establishing a communication between the terminal and the party targeted for communication.

2. The method clamed in claim 1, further comprising the step of:
c. returning the indication of the identity of the party targeted for communication to the terminal.

3. The method clamed in claim 1, further comprising the step of:
c. establishing the communication between the terminal and the party targeted for communication using the indication of the identity of the party targeted for communication to the terminal.

4. The method claimed in claim 1, wherein the information about the party targeted for communication includes a picture of the party targeted for communication, and wherein step b. comprises the step of:
b.1 translating the picture of the party targeted for communication into the indication of the identity of the party targeted for communication for establishing the communication between the terminal and the party targeted for communication.

5. The method claimed in claim 1, wherein the information about the party targeted for communication includes a radio identifier of a mobile terminal of the party targeted for communication, and wherein step b. comprises the steps of:
b.1 translating the radio identifier of the mobile terminal of the party targeted for communication into the indication of the identity of the party targeted for communication for establishing the communication between the terminal and the party targeted for communication.

6. The method claimed in claim 1, wherein:
step a. comprises the step of receiving the information about the party targeted for communication along with location information indicative of a location of at least one of the terminal and the party targeted for communication; and
step b. comprises the step of accessing in a database that comprises location information associated to mobile terminal information associations which location information matches the location information indicative of the location of the at least one of the terminal and the party targeted for communication in order to retrieve the indication of the identity of the party targeted for communication.

7. An application server, comprising:
a communication module receiving information about a party targeted for communication from a terminal that physically points towards the party targeted for communication for acquiring the information;
a database storing a plurality of associations between information of mobile terminals and indications of identities the mobile terminals; and
a processing module that receives from the communication module the information about the party targeted for communication and retrieves from the database an indication of an identity of the party targeted for communication for establishing a communication between the terminal and the party targeted for communication.

8. The application server claimed in claim 7, wherein the communication module returns the indication of the identity of the party targeted for communication to the terminal.

9. The application server claimed in claim 7, wherein the communication module establishes the communication between the terminal and the party targeted for communication using the indication of the identity of the party targeted for communication to the terminal.

10. The application server claimed in claim 7, wherein:
the information about the party targeted for communication includes a picture of the party targeted for communication;
the database stores an association between pictures of users of mobile terminals and indications of identities the mobile terminals; and
the processing module translates the picture of the party targeted for communication into the indication of the identity of the party targeted for communication for establishing the communication between the terminal and the party targeted for communication.

11. The application server claimed in claim 7, wherein:
the information about the party targeted for communication includes a radio identifier of a mobile terminal of the party targeted for communication;
the database stores an association between radio identifiers of mobile terminals and indications of identities the mobile terminals; and
the processing module translates the radio identifier of the mobile terminal of the party targeted for communication into the indication of the identity of the party targeted for communication for establishing the communication between the terminal and the party targeted for communication.

12. The application server claimed in claim 7, wherein:
the database further comprises location information associated to each mobile terminal information;
the communication module receives the information about the party targeted for communication along-with location information indicative of a location of at least one of the terminal and the party targeted for communication; and
the processing module accesses those associations which location information matches the location information indicative of the location of the at least one of the terminal and the party targeted for communication in order to retrieve the indication of the identity of the party targeted for communication.

13. A terminal comprising:
a pointing module arranged to physically point towards a party targeted for communication when the terminal is placed in a certain position, the pointing module acquiring information about the party targeted for communication; and
a communication module communicating with the party targeted for communication based on the information about the party intended for communication.

14. The terminal claimed in claim 13, wherein the communications module sends the information about the party targeted for communication to an application server for translating the information into an indication of an identity of the party targeted for communication for use in communicating with the party targeted for communication.

15. The terminal claimed in claim 14, wherein the communications module receives back from the application server the indication of the identity of the party targeted for communication, and further initiates a communication with the party targeted for communication using the indication of the identity of the party targeted for communication.

16. The terminal claimed in claim 13, wherein:
the pointing module includes a camera; and
the information about the party targeted for communication includes a picture of the party targeted for communication;
wherein the communications module sends the picture of the party targeted for communication to the application server for translating the picture into the indication of the identity of the party intended for communication for use in communicating with the party targeted for communication.

17. The terminal claimed in claim 13, wherein:
the pointing module includes a directive antenna that emits a radio lobe pointing towards the mobile terminal of the party targeted for communication to acquire the radio identifier when the terminal is paced in the certain position; and
the information about the party targeted for communication includes a radio identifier of the mobile terminal of the party targeted for communication;
wherein the communications module sends the radio identifier of the party targeted for communication to the application server for translating the radio identifier into the indication of the identity of the party intended for communication for use in communicating with the party targeted for communication.

18. The terminal claimed in claim 17, wherein the directive antenna sends to the mobile terminal of the party targeted for communication a request for the radio identifier and responsive to the request, the radio identifier of the mobile terminal of the party targeted for communication is received back to the terminal.

19. The terminal claimed in claim 14, wherein step c. comprises the step of sending the information along with location information indicative of a location of at least one of the terminal and the party targeted for communication.

20. A method for communication using a terminal, the method comprising the steps of:
a. acquiring information about a party targeted for communication using the terminal, the terminal being arranged to physically point towards the party targeted for communication to acquire the information; and
b. communicating with the party targeted for communication based on the information about the party intended for communication.

21. The method claimed in claim 20, further comprising the step of:
c. sending the information about the party targeted for communication from the terminal to an application server for translating the information into an indication of an identity of the party intended for communication for use in communicating with the party targeted for communication, wherein step b. is performed using the indication of the identity of the party targeted for communication.

22. The method claimed in claim 21, wherein step c. comprises the steps of:
b.1 receiving from the application server the indication of the identity of the party targeted for communication; and
b.2 initiating a communication with the party targeted for communication using the indication of the identity of the party targeted for communication.

23. The method claimed in claim 20, wherein the information about the party targeted for communication includes a picture of the party targeted for communication and the terminal includes a camera arranged to physically point towards the party targeted for communication to acquire the picture.

24. The method claimed in claim 20, wherein the information about the party targeted for communication includes a radio identifier of a mobile terminal of the party targeted for communication and the terminal includes a directive antenna that emits a radio lobe pointing towards the mobile terminal of the party targeted for communication to acquire the radio identifier.

25. The method claimed in claim 20, wherein step a. comprises the steps of:
a.1 sending to the mobile terminal of the party targeted for communication a request for the radio identifier; and
a.2. responsive to the request, receiving the radio identifier from the mobile terminal of the party targeted for communication.

26. The method claimed in claim 21, wherein step c. comprises the step of sending the information along with location information indicative of a location of at least one of the terminal and the party targeted for communication.
